(19) United States
(12) Patent Application Publication
(10) Pub. No.: US 2014/0179141 A1
(43) Pub. Date: Jun. 26, 2014

(54) PLUG LOCK DEVICE

(71) Applicant: KABUSHIKI KAISHA TOKAI RIKA DENKI SEISAKUSHO, Aichi (JP)

(72) Inventors: Isshu KOJIMA, Aichi (JP); Akihito KIMURA, Aichi (JP); Tadayuki TOBIMATSU, Aichi (JP); Keiji YAMAMOTO, Aichi (JP); Takashi IEDA, Aichi (JP)

(73) Assignee: KABUSHIKI KAISHA TOKAI RIKA DENKI SEISAKUSHO, Aichi (JP)

(21) Appl. No.: 14/107,016

(22) Filed: Dec. 16, 2013

(30) Foreign Application Priority Data
Dec. 20, 2012 (JP) 2012-278249

(51) Int. Cl. H01R 13/629

(52) U.S. Cl. CPC H01R 13/629
USPC 439/296

(57) ABSTRACT

A plug lock device that allows for a power plug fitted to an inlet to be switched between a lock state and an unlock state. The plug lock device includes a communication unit capable of communicating with the power plug and a control unit configured to identify the power plug fitted to the inlet based on the communication performed by the communication unit. The control unit is operable based on the identification of the power plug in a lock restriction mode that restricts switching of the power plug to the lock state.

### CROSS-REFERENCE TO RELATED APPLICATIONS

This application is based upon and claims the benefit of priority from prior Japanese Patent Application No. 2012-278249, filed on Dec. 20, 2012, the entire contents of which are incorporated herein by reference.

### FIELD

The present invention relates to a plug lock device.

### BACKGROUND

Electric vehicles and hybrid vehicles that are powered by batteries are environment-friendly and have become popular. Such a vehicle includes an inlet that allows for connection of a power plug. For example, a power plug of a commercial power supply is connected to the inlet to supply power that charges the battery.

A plug lock device that locks the power plug to the inlet has been developed so that the power plug cannot be removed in an unauthorized manner from the vehicle during battery charging and so that that the power plug cannot be stolen.

Japanese Patent No. 4379823 describes a plug lock device that locks and unlocks the power plug in accordance with the locking and unlocking of the vehicle doors.

### SUMMARY

The plug lock device of the above patent locks and unlocks the power plug in accordance with the locking and unlocking of the vehicle doors regardless of the user's intention. However, the user may not wish to lock the power plug depending on the situation.

For example, when a user charges the battery outside his or her home, the power plug that is locked may not belong to the user. In this case, after battery charging is completed, the user still has to switch the vehicle doors from a lock state to an unlock state in order to remove the power plug from the vehicle inlet.

If the battery is charged when the vehicle is parked in a home garage, the level of security does not have to be that high. Thus, there is no need to lock the power plug. Nevertheless, when removing the power plug from the inlet, the vehicle doors have to be switched from a lock state to an unlock state in order to unlock the power plug. This is inconvenient to the user.

Namely, the conventional plug lock device locks and unlocks the power plug whenever the vehicle doors are switched between a lock state and an unlock state. This causes inconvenience for the user.

One example of the present invention is a plug lock device that allows for a power plug fitted to an inlet to be switched between a lock state and an unlock state. The plug lock device includes a communication unit capable of communicating with the power plug. A control unit is configured to identify the power plug fitted to the inlet based on the communication performed by the communication unit. The control unit is operable based on the identification of the power plug in a lock restriction mode that restricts switching of the power plug to the lock state.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram of a vehicle and an electronic key in one embodiment;

FIG. 2 is a block diagram illustrating the connection of a power plug to an inlet in the embodiment of FIG. 1;

FIG. 3 is a schematic sequence chart of communication performed between a plug lock ECU and a transponder in the embodiment of FIG. 1; and

FIG. 4 is a schematic sequence chart of the processing performed by the plug lock ECU in the embodiment of FIG. 1.

### DESCRIPTION OF THE EMBODIMENTS

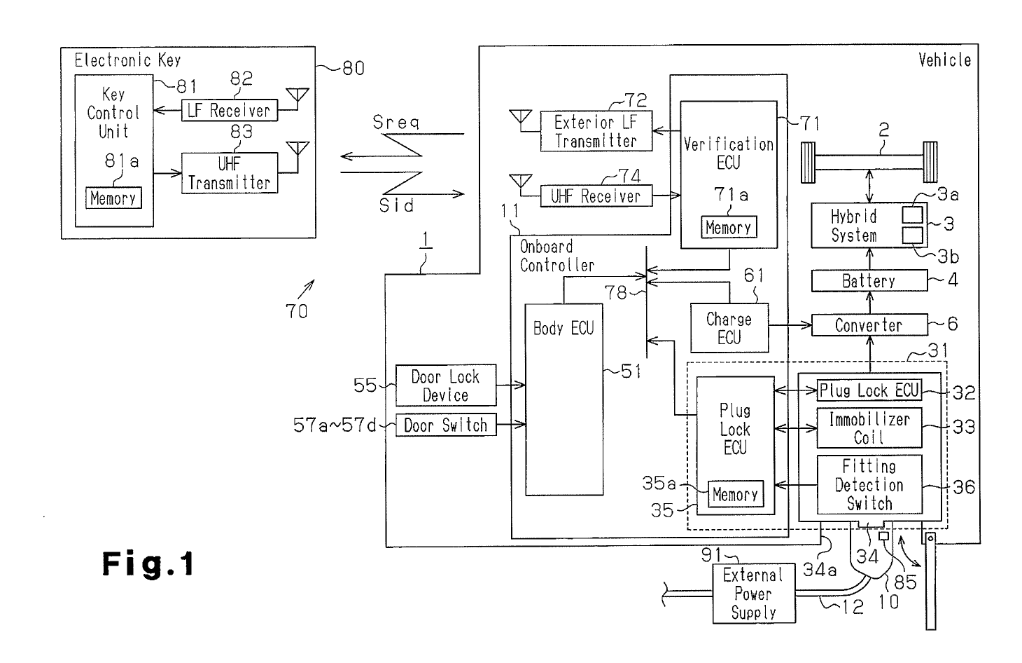

One embodiment of a plug lock device will now be described with reference to FIGS. 1 to 4.

Referring to FIG. 1, a vehicle 1 is a hybrid vehicle. The vehicle 1 performs wireless communication with an electronic key 80 to control the locking and unlocking of the vehicle doors.

In the present example, the vehicle 1 employs a smart key system, which serves as an electronic key system. When bidirectional wireless communication is performed between the vehicle 1 and the electronic key 80, the locking and unlocking of the vehicle doors is permitted. The structure of the electronic key 80 and the vehicle 1 will now be described.

[Electronic Key]

Referring to FIG. 1, the electronic key 80 includes a key control unit 81, an LF receiver 82, and a UHF transmitter 83.

The key control unit 81 includes a non-volatile memory 81a that stores a unique key ID code. The key control unit 81 receives a request signal Sreq, which is transmitted from the vehicle 1 through wireless communication on a low frequency (LF) band, with the LF receiver 82. In response to the request signal Sreq, the key control unit 81 transmits a key ID code signal Sid, which includes the key ID code stored in the memory 81a, from the UHF transmitter 83 through wireless communication on the ultrahigh frequency (UHF) band.

[Vehicle]

Referring to FIG. 1, the vehicle 1 includes an onboard controller 11. The onboard controller 11 includes a verification electronic control unit (ECU) 71, a charge ECU 61, a body ECU 51, and a plug lock ECU 35. The ECUs 35, 51, 61, and 71 are connected with one another in a communicable manner by an in-vehicle local area network (LAN).

The vehicle 1 includes a hybrid system 3, an onboard battery 4, and a plug lock device 31. The hybrid system 3 combines the power of an engine 3a and a motor 3b to drive wheels 2. The battery 4 is a rechargeable battery that supplies electric power to the motor 3b. The plug lock device 31 controls the locking and unlocking of a power plug 10 connected to the vehicle 1.

Referring to FIG. 1, the vehicle 1 has a side wall (e.g., behind rear right door) that includes an inlet 34. The inlet 34 includes a plug lock structure 32 that switches the power plug 10 that is fitted to the inlet 34 between a lock state and an unlock state.

When the power plug 10 is fitted to the inlet 34, the inlet 34 and a converter 6 connect the power plug 10 to the battery 4. A charge cable 12 supplies the power plug 10 with electric power from an external power supply 91. Accordingly, when the power plug 10 is fitted to the inlet 34, AC power from the external power supply 91 may be supplied to the converter 6 through the power plug 10 and the inlet 34. The converter 6 converts the AC power from the power plug 10 to DC power. Then, the converter 6 supplies the battery 4 with the DC power. The charge ECU 61 drives the converter 6 and controls the charging of the battery 4.

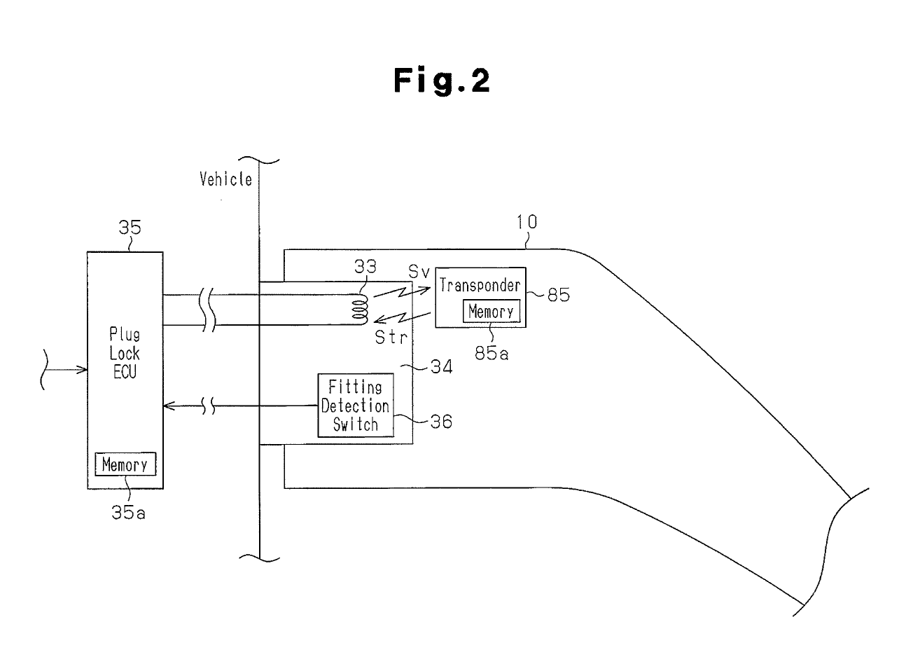

Referring to FIG. 2, the inlet 34 includes a fitting detection switch 36, which detects the power plug 10 when fitted to the inlet 34, and an immobilizer coil 33. The fitting detection switch 36 is a push switch that is pushed when the power plug 10 is fitted to the inlet 34 and provides the plug lock ECU 35 with a detection signal corresponding to the pushed state. The immobilizer coil 33 is electrically connected to the plug lock ECU 35. The plug lock ECU 35 includes a non-volatile memory 35a. The power plug 10 incorporates a transponder 85 that stores a transponder ID code. The memory 35a of the plug lock ECU 35 stores in advance the transponder ID code of the transponder 85. The task for registering the power plug 10 (transponder ID code) to the vehicle 1 is performed, for example, at a car dealer upon request from the user. The immobilizer coil 33 is an example of a communication unit. The transponder ID code is one example of identification information.

The plug lock ECU 35 is capable of controlling and selectively switching two operation modes, namely, a cooperative mode and a lock restriction mode. In the cooperative mode, the plug lock ECU 35 maintains the power plug 10 in an unlock state on the inlet 34 when the vehicle doors are unlocked and maintains the power plug 10 in a lock state when the vehicle doors are locked. That is, the plug lock ECU 35 locks and unlocks the power plug 10 in accordance with the locking and unlocking of the vehicle doors. In the lock restriction mode, the plug lock ECU 35 restricts switching of the power plug 10 to a lock state.

Referring to FIG. 2, when the plug lock ECU 35 determines from the detection signal of the fitting detection switch 36 that the power plug 10 has been fitted to the inlet 34, the plug lock ECU 35 transmits drive radio waves Sv from the immobilizer coil 33.

When the plug lock ECU 35 receives a transponder response signal Str from the power plug 10 via the immobilizer coil 33, the plug lock ECU 35 acquires a transponder ID code from the transponder response signal Str. Then, the plug lock ECU 35 uses the transponder ID code stored in the memory 35a to perform transponder verification and determine whether or not the transponder verification has been accomplished.

When transponder verification is accomplished, the plug lock ECU 35 operates in the cooperative mode. When the transponder verification is not accomplished, the plug lock ECU 35 operates in the lock restriction mode. When the power plug 10 is not fitted to the inlet 34, the plug lock ECU 35 is neither in the lock restriction mode nor the cooperative mode.

Referring to FIG. 1, the body ECU 51 is connected to a door lock device 55 and door switches 57a to 57d. Each of the door switches 57a to 57d is arranged on an outer door handle of one of the vehicle doors and provides the body ECU 51 with an operation signal when operated (e.g., pushed) by the user.

The verification ECU 71 includes a memory 71a that stores the key ID code of the electronic key 80 registered to the vehicle 1. The verification ECU 71 is connected to exterior LF transmitters 72 and a UHF receiver 74.

The exterior LF transmitter 72 is arranged in the outer door handle of each vehicle door and transmits wireless signals on the LF band to the surrounding of the vehicle 1. The UHF receiver 74 receives wireless signals on the UHF band from inside and outside the vehicle 1. Then, the UHF receiver 74 provides the verification ECU 71 with the received signals.

For example, when the engine is stopped and the vehicle doors are locked, the verification ECU 71 transmits the request signal Sreq in fixed cycles from each exterior LF transmitter 72 to the surrounding of the vehicle 1.

When the verification ECU 71 receives a key ID code signal Sid via the UHF receiver 74 from the electronic key 80 in response to the request signal Sreq, the verification ECU 71 acquires the key ID code from the key ID code signal Sid. Then, the verification ECU 71 performs ID verification with the key ID code stored in the memory 71a, that is, exterior verification related to door locking and unlocking control, and notifies the body ECU 51 of whether or not the exterior verification has been accomplished. If one of the door switches 57a to 57d is operated when the exterior verification is accomplished, the body ECU 51 drives the door lock device 55 to switch the vehicle doors between the lock and unlock states. In this manner, the vehicle doors are locked or unlocked with the smart key system.

[Power Plug]

The transponder 85 incorporated in the power plug 10 includes a non-volatile memory 85a, which stores the unique transponder ID code.

The transponder 85 is operated by drive radio waves Sv transmitted from the vehicle 1 (immobilizer coil 33). When the transponder 85 receives the drive radio waves Sv, the transponder 85 transmits, through wireless communication, a transponder response signal Str that includes the transponder ID code stored in the memory 85a.

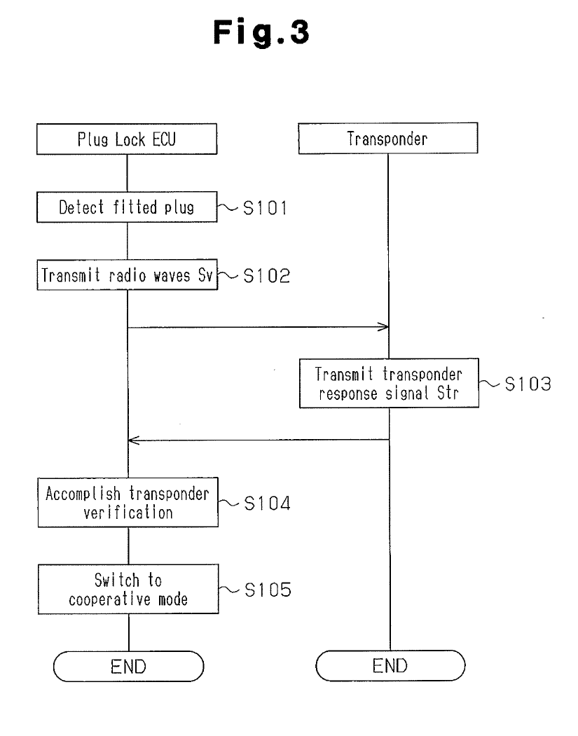

The communication performed between the plug lock ECU 35 and the transponder 85 when an operation mode switch control is executed will now be described with reference to the sequence chart of FIG. 3. A case in which the power plug 10 is registered in advance to the vehicle 1 and fitted to the inlet 34 will now be described.

When the plug lock ECU 35 determines from the detection signal of the fitting detection switch 36 that the power plug 10 is fitted to the inlet 34 (S101), the plug lock ECU 35 transmits drive radio waves Sv from the immobilizer coil 33 (S102).

When the transponder 85 receives the drive radio waves Sv, the transponder 85 transmits, through wireless communication, a transponder response signal Str, which includes the transponder ID code stored in the memory 85a (S103).

When the plug lock ECU 35 receives the transponder response signal Str, the plug lock ECU 35 verifies the transponder ID code of the transponder response signal Str with the transponder ID code stored in the memory 35a to perform transponder verification. When the transponder verification is accomplished (S104), the plug lock ECU 35 switches the operation mode to the cooperative mode (S105). This allows only the power plug 10 that is registered to the vehicle 1 to be locked in cooperation with the locking of the vehicle doors.

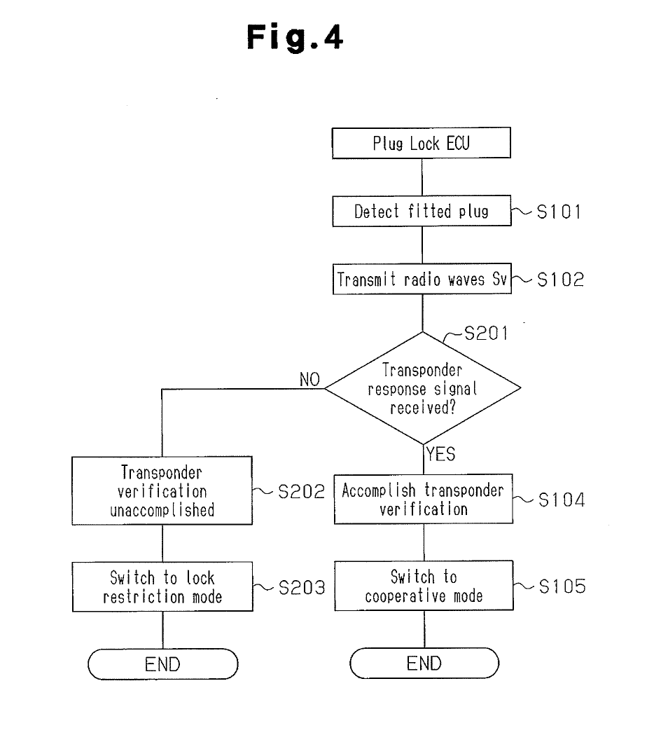

When a power plug that is fitted to the inlet 34 is not registered to the vehicle 1 or does not incorporate the transponder 85, transponder verification is not accomplished. The processing performed in this case will now be described. Referring to FIG. 4, after the plug lock ECU 35 transmits the drive radio waves Sv in step S102, which is described above, the plug lock ECU 35 determines whether or not the transponder response signal Str has been received (S201). When the transponder response signal Str has been received, the plug lock ECU 35 performs transponder verification as described above. When transponder verification is accomplished (S104), the plug lock ECU 35 switches the operation mode to the cooperative mode (S105). When the plug lock ECU 35 does not receive the transponder response signal Str, transponder verification is unaccomplished (S202). Thus, the plug lock ECU 35 operates in the lock restriction mode (S203). Accordingly, the power plug that is not registered to the vehicle 1 is not locked.

The present embodiment has the advantages described below.

(1) The plug lock ECU 35 switches the operation mode between the cooperative mode and the lock restriction mode. In the cooperative mode, the plug lock ECU 35 locks the power plug 10 when the vehicle doors are locked and unlocks the power plug 10 when the vehicle doors are unlocked. In the lock restriction mode, the plug lock ECU 35 restricts locking of the power plug 10. In other words, in the lock restriction mode, the power plug 10 remains unlocked regardless of the locking and unlocking of the vehicle doors.

When the plug lock ECU 35 determines that transponder verification has been accomplished, the plug lock ECU 35 determines that the power plug 10 fitted to the inlet 34 is registered in advance to the vehicle 1. In this case, the plug lock ECU 35 switches the operation mode to the cooperative mode. When the plug lock ECU 35 determines that transponder verification has not been accomplished, the plug lock ECU 35 determines that the power plug 10 fitted to the inlet 34 has not been registered in advance to the vehicle 1. In this case, the plug lock ECU 35 switches the operation mode to the lock restriction mode.

The user does not register a power plug, which does not have to be locked, to the vehicle 1. For example, a power plug used at a charging station or used at the user's home garage does not have to be registered to the vehicle 1. Thus, such a power plug is not locked. Accordingly, such a power plug remains unlocked, and the user does not have to hold the electronic key 80 near the vehicle 1 to unlock the vehicle doors after the battery 4 is charged. This allows for easy removal of the power plug from the inlet 34 and improves convenience for the user.

(2) The user registers to the vehicle 1 the power plug 10 that has to be locked, such as one used in a parking lot outside the user's home. This allows for the power plug 10 to be locked in cooperation with the locking of the vehicle doors and thus improves security.

(3) Only the power plug 10 that has to be locked is registered to the vehicle 1. Since there is no need to register power plugs such as one used at a charging station, the registration task is facilitated.

(4) The transponder 85 eliminates the need for a battery and uses the drive radio waves Sv as a power source to transmit the transponder response signal Str. Thus, there is no need to worry about battery replacement or battery drainage in the power plug 10.

It should be apparent to those skilled in the art that the present invention may be embodied in many other specific forms without departing from the spirit or scope of the invention. Particularly, it should be understood that the present invention may be embodied in the following forms.

In the above embodiment, the plug lock ECU 35 operates in the cooperative mode when determining that transponder verification has been accomplished and operates in the lock restriction mode when determining that transponder verification has not been accomplished. Instead, the plug lock ECU 35 may operate in the lock restriction mode when determining that transponder verification has been accomplished and operates in the cooperative mode when determining that transponder verification has not been accomplished. In this case, the user registers to the vehicle 1 the power plug 10 that does not have to be locked, such as one used in a home garage. Thus, the power plug 10 registered by the user does not undergo unnecessary locking.

In the above embodiment, the plug lock ECU 35 switches the operation mode between the lock restriction mode and the cooperative mode in accordance with whether or not transponder verification is accomplished. Instead of using the result of the transponder verification, the plug lock ECU 35 may switch between the lock restriction mode and the cooperative mode in accordance with the transponder ID code acquired from the transponder response signal Str. For example, when the plug lock ECU 35 determines that the transponder ID code corresponds to a power plug (transponder 85) of a charging station, the plug lock ECU 35 switches the operation mode to the lock restriction mode. Thus, the power plug of the charging station does not undergo unnecessary locking. In this case, one or more ID codes that identify one or more power plugs that do not have to be locked are registered in advance to the plug lock ECU 35.

In the above embodiment, the plug lock ECU 35 restricts locking of power plugs that are not registered to the vehicle 1. Instead, the plug lock ECU 35 may operate in the lock restriction mode when determining that the power plug 10 fitted to the inlet 34 is a rapid charging power plug and operate in the cooperative mode when determining that the power plug 10 is a normal charging power plug. In this manner, the plug lock ECU 35 may switch between the lock restriction mode and the cooperative mode in accordance with the power plug type. In this case, there is no need to register the power plug in advance to the vehicle 1. Since the power plug 10 for rapid charging at a charging station is not locked, the power plug 10 is removable. This improves the user convenience.

In the above embodiment, the vehicle 1 employs the smart key system but may employ a wireless key system. In the wireless key system, a lock-and-unlock button is operated on the electronic key to transmit a lock-and-unlock request signal to lock and unlock the vehicle doors.

Further, a mechanical key may be used to lock and unlock the vehicle doors. In this case, the user inserts the mechanical key into a key cylinder arranged in an outer door handle of a vehicle door. Then, the user turns the mechanical key to lock or unlock the vehicle doors.

In any of the wireless ley system and the mechanical key system, the power plug 10 is locked and unlocked in accordance with the locking and unlocking of the vehicle doors in the cooperative mode.

A trigger switch operated by the user to lock and unlock the power plug 10 may be arranged in the vicinity of the inlet 34. When using such a trigger switch, a lock permission mode is set in lieu of the cooperative mode. In the lock permission mode, the plug lock ECU 35 locks the power plug 10 when the user operates the trigger switch. In the lock restriction mode, the plug lock ECU 35 restricts locking of the power plug 10 regardless of operation of the trigger switch.

In the above embodiment, the fitting detection switch 36 is a push switch that is pushed when the power plug 10 is fitted to the inlet 34. However, the fitting detection switch 36 does not have to be a push switch as long as the power plug 10 fitted to the inlet 34 may be detected. Further, a plug detection switch may be used in lieu of the fitting detection switch 36 to detect that the power plug 10 has been electrically connected to the inlet 34.

In the above embodiment, the plug lock ECU 35 transmits the drive radio waves Sv from the immobilizer coil 33 when determining from the detection signal of the fitting detection switch 36 that the power plug 10 has been fitted to the inlet 34. However, the plug lock ECU 35 may cyclically transmit the drive radio waves Sv. Further, the plug lock ECU 35 may transmit the drive radio waves Sv during a fixed period from when the engine is stopped.

In the above embodiment, communication between the plug lock ECU 35 and the power plug 10 (transponder 85) is not limited to wireless communication performed through the immobilizer coil 33 (communication unit) and may be communication performed through a wired connection. That is, the communication unit is not limited to a wireless communication unit that uses the immobilizer coil 33 and may be a wired communication unit. In this case, the plug lock ECU 35 may function as a communication unit. When the power plug 10 is fitted to the inlet 34, the communication unit arranged in the power plug 10 is connected to the plug lock ECU (communication unit) by a communication line. This allows for wired communication between the power plug 10 and the plug lock ECU 35. The wired communication allows for the fitting detection switch 36 to be omitted.

In the above embodiment, the transponder ID code is used as the identification information. However, the ID code of the power plug 10 may be used as the identification information.

In the above embodiment, the vehicle 1 is a hybrid vehicle but may be an electric vehicle.

The present examples and embodiments are to be considered as illustrative and not restrictive, and the invention is not to be limited to the details given herein, but may be modified within the scope and equivalence of the appended claims.

1. A plug lock device that allows for a power plug fitted to an inlet to be switched between a lock state and an unlock state, the plug lock device comprising:
a communication unit capable of communicating with the power plug;
a control unit configured to identify the power plug fitted to the inlet based on the communication performed by the communication unit, wherein the control unit is operable based on the identification of the power plug in a lock restriction mode that restricts switching of the power plug to the lock state.

2. The plug lock device according to claim 1, wherein
the control unit is switchable between a cooperative mode and the lock restriction mode,
the control unit is configured to, in the cooperative mode, lock the power plug when a vehicle door is locked and unlock the power plug when the vehicle door is unlocked, and
the control unit is configured to operate in the cooperative mode when determining that the power plug has been registered in advance to the vehicle and operate in the lock restriction mode when determining that the power plug has not been registered in advance to the vehicle.

3. The plug lock device according to claim 1, wherein
the control unit is switchable between a cooperative mode and the lock restriction mode,
the control unit is configured to, in the cooperative mode, lock the power plug when a vehicle door is locked and unlock the power plug when the vehicle door is unlocked, and
the control unit is configured to operate in the lock restriction mode when determining that the power plug is a rapid charging power plug and operate in the cooperative mode when determining that the power plug is a normal charging power plug.

4. The plug lock device according to claim 2, wherein the control unit is configured to switch between the cooperative mode and the lock restriction mode in accordance with whether or not identification information is received from the power plug through the communication unit.

5. The plug lock device according to claim 1, wherein the control unit is configured to receive identification information from the power plug through the communication unit and identify the power plug based on the identification information.

6. The plug lock device according to claim 1, wherein the communication performed between the communication unit and the control unit is wireless communication.

7. The plug lock device according to claim 1, wherein
the communication unit includes an immobilizer coil arranged in the inlet,
the power plug includes a transponder capable of receiving drive radio waves from the immobilizer coil,
the transponder is configured to store a unique ID code and transmit, through wireless communication, a response signal that includes the ID code in response to the drive radio waves from the immobilizer coil; and
the control unit is configured to receive the response signal from the transponder, acquire the ID code from the response signal, and identify the power plug with the ID code.
